(19) United States
(12) Patent Application Publication
(10) Pub. No.: US 2024/0351137 A1
(43) Pub. Date: Oct. 24, 2024

(54) METHOD AND APPARATUS FOR WELDING COMPONENTS BY MEANS OF A LASER BEAM

(71) Applicant: Robert Bosch GmbH, Stuttgart (DE)

(72) Inventor: Alexander Ilin, Ludwigsburg (DE)

(21) Appl. No.: 18/556,229

(22) PCT Filed: Apr. 21, 2022
(86) PCT No.: PCT/EP2022/060484

§ 371 Date: Oct. 19, 2023

(30) Foreign Application Priority Data
Apr. 23, 2021 (DE) 10 2021 204 065.9

(51) Int. Cl. B23K 26/042; B23K 26/03; B23K 26/26; B23K 26/70; B23K 101/18; B23K 101/38

(52) U.S. Cl. CPC B23K 26/042; B23K 26/032; B23K 26/26; B23K 26/70; B23K 2101/18; B23K 2101/38

(57) ABSTRACT

The invention relates to a method for welding components (1, 2) by means of a laser beam (11), in which the laser beam (11) is moved along a joining zone (16) of the components (1, 2), wherein the material of the components (1, 2) is melted in the region of the joining zone (16), wherein the melt solidifies to form a weld seam (24) at a distance from the laser beam (11), and wherein a region (20) trailing the laser beam (11) is heated by means of a further laser beam (26).

### BACKGROUND OF THE INVENTION

The invention relates to a method for welding components by means of a laser beam, in particular a method in which the laser beam and the components to be welded move relative to one another at relatively high speed. Furthermore, the invention relates to an apparatus for carrying out the method according to the invention.

A method for welding two components by means of a laser beam is known from DE 10 2011 004 116 A1 of the applicant. In the known method, a laser beam is moved along a joining zone of the components, wherein the material of the components is melted in the area of the joining zone, and wherein the melt solidifies into a weld seam at a distance or spacing from the laser beam. It is also known from the literature that, in order to improve the quality of the weld seam, a further laser beam is used at a distance from or in the trailing area of the laser beam, which heats the material of the components in the joining zone. As a result, more stable flow rates with lower flow velocities can be achieved within the melt in the trailing area, which is enlarged in volume, so that in particular there is no disruptive backflow in the region of a capillary created by the laser beam. Furthermore, it is disclosed in said document to additionally move the laser beam in the trailing area in the component plane, for example in a direction transverse or longitudinal to the feed direction of the two laser beams.

### SUMMARY OF THE INVENTION

The method according to the invention for welding components by means of a laser beam has the advantage that it enables a particularly high quality of the weld seam, in particular at relatively high relative speeds between the laser beam generating the molten bath and the components to be welded together. The invention is based on the idea of controlling the distance at which the (further) laser beam following the leading laser beam follows on the basis of monitoring the molten bath, i.e. in particular also enabling a variable distance to the leading laser beam or a distance adapted to the molten bath.

Against the background of the above explanations, the method according to the invention for welding components by means of a laser beam according to the disclosure therefore proposes that the trailing area of the molten bath be recorded by means of a recording device, that the data of the trailing area recorded by the recording device be evaluated, and that in dependence on the evaluation at least one parameter of the further laser beam be changed in the event of a deviation of the data from predetermined values.

The invention thus also comprises embodiments in which, as a function of the recorded data or deviation of the recorded data from predetermined values, not only the distance to the leading laser beam in the trailing area is changed, but also, for example, the laser power or a possible direction of movement of the trailing laser beam relative to the feed direction.

Advantageous further developments of the method according to the invention for welding components by means of a laser beam are listed in the subclaims.

It is particularly preferred if the at least one parameter comprises a change in the movement of the further laser beam, in particular a change in the distance to the laser beam and/or a laser power of the further laser beam and/or a focal position of the further laser beam relative to the surface of the melt.

Furthermore, it is particularly preferred if the recording device is an image-recording recording device, wherein the recorded images of the trailing area are evaluated by means of an algorithm.

In further development of such an evaluation, it is provided that the recorded images are continuously evaluated in order to enable a particularly fast control of the further laser beam to increase the quality of the weld seam.

In order to be able to dispense with the performance of extensive tests, particularly in new applications or initial applications, it is also advantageous if the at least one parameter of the additional laser beam is determined or set in advance by means of a numerical simulation.

As already explained, the method according to the invention is preferably used in applications where high productivity or a high relative speed between the laser beam and the components to be welded together is required or desired. This refers in particular to applications in which the laser beam is moved relative to the components in the area of the joining zone at a speed of between 0.1 m/s and 0.5 m/s.

A particularly preferred use of the method is in welding two bipolar plates of a fuel cell, in particular two FCEV (fuel cell electric vehicle) bipolar plates, within the framework of fuel cell technology.

Furthermore, the invention also comprises an apparatus for welding components by means of a laser beam, in particular according to a method according to the invention described so far, wherein the apparatus comprises at least one laser beam device for generating the laser beam and for melting material of the components in a joining zone as well as another laser beam. Furthermore, means are provided for moving the further laser beam in the area of the trailing zone of the laser beam. The apparatus according to the invention is characterized by the fact that a recording device is provided which records the trailing zone of the (leading) laser beam and evaluates the data recorded by the recording device by means of evaluation means and influences at least one parameter of the further laser beam by means of a regulating device.

It is particularly preferred if the recording device is configured as an image-recording device.

Furthermore, it is advantageous if a regulating device that can be controlled by the adjusting device is provided for influencing the distance between the laser beam and the further laser beam.

Further advantages, features and details of the invention will emerge from the following description of preferred embodiments of the invention and from the drawing.

### BRIEF DESCRIPTION OF THE DRAWING

FIG. 1 shows a simplified representation of an apparatus for welding two components by means of a laser beam and a further laser beam following the laser beam in a trailing zone, and

FIG. 2 shows a top view of the components in the direction of plane II-II of FIG. 1.

### DETAILED DESCRIPTION

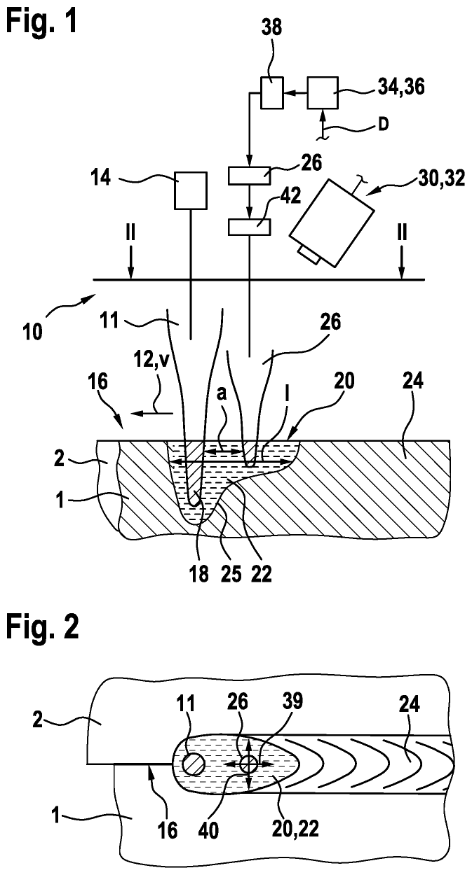

FIG. 1 shows in highly simplified form the essential components of an apparatus 10 for joining two components 1, 2 by means of a laser beam 11. The two components 1, 2 serve as components of (FCEV) bipolar plates of a fuel cell and are typically in the form of thin sheets. In particular, the material of the components 1, 2 comprises aluminum or an aluminum alloy or copper or a copper alloy, respectively. The method described in more detail below can also be applied in one variant to other materials. Furthermore, the laser beam 11 is moved in the direction of the arrow 12 relative to the components 1, 2 at a feed rate v of typically between 0.1 m/s and 0.5 m/s.

It is additionally mentioned that it is also within the scope of the invention to generate the relative movement between the laser beam 11 and the components 1, 2 by moving the components 1, 2 relative to a stationary laser beam 11.

In FIG. 1, the two components 1, 2 are arranged perpendicular to the drawing plane, so that in the representation of FIG. 1, the rear component 2 in the drawing plane is hidden by the front component 1. Furthermore, a small distance perpendicular to the drawing plane of FIG. 1 is formed between the two components 1, 2, if necessary.

The laser beam 11 is generated by means of a laser beam device 14 as known per se from the prior art. The laser beam 11 forms a vapor capillary 18 in the area of a joining zone 16 of the two components 1, 2. The laser beam 11 heats the two components 1, 2 to a temperature that is above the melting temperature of the material of the two components 1, 2. Furthermore, the laser beam 11 is moved in the direction of the arrow 12 along the components 1, 2 or along the joining zone 16 by means not shown (scanner optics or similar).

As the laser beam 11 moves along in the direction of the arrow 12, a trailing area 20 containing liquid melt 22 of the material of the two components 1, 2 is formed, wherein the melt 22 gradually solidifies into a weld seam 24 at a spacing or a distance from the laser beam 11. The transition region between the liquid melt 22 and the solidified region of the weld 24 is indicated by a boundary line 25 in FIG. 1.

Furthermore, an additional heat source in the form of another laser beam 26 is provided in the trailing area 20 of the laser beam 11, which acts on the melt 22 in the trailing area 20. As a result, the melt 22 in the trailing area 20 is heated additionally or again, so that a trailing area 20 with liquid melt 22 is formed which is extended or enlarged in its length 1 and in its volume.

In the illustrated embodiment example, the additional or further laser beam 26 is generated by an additional laser beam device 28. Alternatively, it is intended to generate the further laser beam 26 by decoupling from the laser beam 11. In the case of an additional or separate laser beam device 28, the means for moving the two laser beam devices 14 and 28 are preferably coupled to each other or formed as common means.

It is essential that the further laser beam 26 is tracked at a controlled distance a to the laser beam 11 or has the corresponding distance a from the laser beam 11. Furthermore, the additional laser beam 26 has such a power that the temperature in the trailing area 20 is lower than the temperature generated by the laser beam 11 to weld the two components 1, 2 together.

Furthermore, the apparatus 10 comprises a recording device 30 in the form of a (image-recording) video camera 32. The recording device 30 or video camera 32 records the trailing area 20 of the joining zone 16. The data D recorded by the recording device 30 are fed to a control apparatus 34, which has an algorithm 36 that is configured to evaluate the data D and, in particular, to influence at least one parameter of the further laser beam 26 in the event of a deviation from predetermined values. The data comparison between the data D and predetermined values serves to improve the quality of the weld 24, i.e., the algorithm 36 examines the data D with a view to quality-influencing characteristics.

Furthermore, the control device 34 is coupled to the laser beam device 28 via a control module 38 and a distance regulating device 42, for example in the form of a scanner optics, in order to change in particular the distance a as a parameter influencing the quality of the weld seam 24 between the further laser beam 26 and the laser beam 11. The data D are continuously recorded and evaluated by means of the control device 34 in order to enable the further laser beam 26 to be controlled as promptly as possible with respect to the at least one parameter, in particular with respect to the distance a.

It is additionally mentioned that the at least one parameter for influencing the further laser beam 26 may also comprise an influence on the laser power of the further laser beam 26, its focal position, or else a movement perpendicular to the drawing plane of FIG. 1, as is to be illustrated by the double arrows 39 and 40 in FIG. 2.

The method described so far or the apparatus 10 can be changed or modified in a variety of ways without departing from the idea of the invention.

1. A method for welding components (1, 2) by means of a laser beam (11), the method comprising
moving the laser beam (11) along a joining zone (16) of the components (1, 2),
melting the material of the components (1, 2) in the region of the joining zone (16),
solidifying the melt to form a weld seam (24) at a distance from the laser beam (11),
heating a region (20) trailing the laser beam (11) via a further laser beam (26),
recording the trailing area (20) via of a recording device (30),
evaluating data (D) of the trailing area (20) recorded by the recording device (30), and
changing, as a function of the evaluation, at least one parameter of the further laser beam (26) when a deviation of the data (D) from predetermined values occurs.

2. The method according to claim 1,
wherein
the at least one parameter comprises a change in the movement of the further laser beam (26).

3. The method according to claim 1,
wherein
the recording device (30) records images as an image-recording video camera (32) and the recorded images are converted into data (D) which are evaluated by means of an algorithm (36).

4. The method according to claim 3,
wherein
the evaluation of the recorded images is continuous.

5. The method according to claim 1,
wherein
the at least one parameter of the further laser beam (26) is set in advance by means of a numerical simulation.

6. The method according to claim 1,
wherein
the laser beam (11) is moved in the region of the joining zone (16) at a velocity (v) of 0.1 m/s to 1.0 m/s, preferably of 0.1 m/s to 0.5 m/s.

7. A use of the method according to claim 1 for welding two bipolar plates, in particular two FCEV bipolar plates, as components (1, 2).

8. An apparatus (10) for welding components (1, 2) by means of a laser beam (11), the apparatus comprising:
at least one laser beam device (14, 28) for generating the laser beam (11) and for melting material of the components (1, 2) in a joining zone (16);
a further laser beam (26), and
a means for moving the further laser beam (26) in the region of a trailing area (20) of the laser beam (11),
wherein
a recording device (30) is provided which records the trailing area (20) of the laser beam (11), having evaluation means for evaluating the data (D) recorded by the recording device (30), and having a regulating device (38) for influencing at least one parameter of the further laser beam (26).

9. The apparatus according to claim 8,
wherein
the recording device (30) is configured as an image-recording device.

10. The apparatus according to claim 8,
wherein
a regulating device (42) controllable by the adjusting device (38) is provided for influencing the distance (a) between the laser beam (11) and the further laser beam (26).
